(19) United States
(12) Patent Application Publication
(10) Pub. No.: US 2015/0175836 A1
(43) Pub. Date: Jun. 25, 2015

(54) LOW BAKE TEMPERATURE CURABLE COATING COMPOSITIONS AND PROCESSES FOR PRODUCING COATINGS AT LOW BAKE TEMPERATURES

(71) Applicant: AXALTA COATING SYSTEMS IP CO., LLC, Wilmington, DE (US)

(72) Inventors: Ayumu Yokoyama, Wallingford, PA (US); Henry A. Tronco, Jr., Springfield, PA (US); Eric C. Houze, Mullica Hill, NJ (US); Sheau-Hwa Ma, West Chester, PA (US); Kurt A. Hankerson, Newark, DE (US); Jose Antonio Garcia, Cherry Hill, NJ (US); Gary W. Nickel, Sewell, NJ (US); Delson Jayme Trindade, Rochester Hills, MI (US); Monika J. Sienkowska, Philadelphia, PA (US); Jingguo Shen, West Chester, PA (US)

(21) Appl. No.: 14/500,562

(22) Filed: Sep. 29, 2014

Related U.S. Application Data
(63) Continuation-in-part of application No. 14/134,819, filed on Dec. 19, 2013.

(51) Int. Cl. C09D 133/14; C08K 3/36

(52) U.S. Cl. CPC C09D 133/14; C08K 3/36

(57) ABSTRACT

The present invention is directed to a solvent borne low bake curable coating composition having improved sag resistance and coatings properties and process for using the same. The composition includes a crosslinkable component having one or more polymers having two or more crosslinkable groups, a crosslinking component comprising one or more crosslinking agents having crosslinking groups; and a low bake temperature control agent that includes a rheology component and polyurea. When a layer of a pot mix resulting from mixing of the crosslinkable and crosslinking components is applied over a substrate, it has high sag resistance while providing desired coating properties, such as high gloss and rapid cure even under low bake cure conditions. The solvent borne coating compositions is well suited for use in automotive refinish applications as well as industrial applications, such as construction and transportation equipment.

### CROSS-REFERENCE TO RELATED APPLICATION

This application claims the benefit of U.S. application Ser. No. 14/134,819, filed Dec. 19, 2013, which is hereby incorporated by reference in its entirety.

### TECHNICAL FIELD

The present invention relates to curable compositions and more particularly relates to low VOC (volatile organic component) low bake temperature curable coating compositions suitable for use in automotive OEM (original equipment manufacturer) and refinish applications and processes for producing coatings at low bake temperatures.

### BACKGROUND

A number of clear and pigmented coating compositions are utilized in various coatings, such as, for example, primer coats, basecoats and clearcoats used in automotive coatings, which are generally solvent based.

Multi-coat systems were developed to satisfy a need for improved aesthetics of the coated substrate. A multi-coat system typically includes a primer coat, followed by a basecoat, which is typically pigmented and then finally a clearcoat that imparts a glossy appearance of depth that has commonly been called “the wet look”.

In order to improve the manufacturing efficiency and also to lower production costs, it is important in a multi-coat system to speedily dry (thus lowering production cycle time) and/or cure intermediate layers (such as basecoats sandwiched between the primer and clear coats) at lower bake temperatures (thus lowering manufacturing costs) so that subsequent layers can be applied without adversely affecting the coatings properties, such as gloss or bleeding of base coat into the subsequently applied clear coat layer. One way to ensure the foregoing process is to improve, i.e., to increase the sag resistance of a coating composition, especially the one used for of an intermediate basecoat. Sag resistance is the resistance of a basecoat layer of a coating composition to sag when applied over a slanted or vertical substrate surface.

One approach to improve the sag resistance has been disclosed in a commonly assigned US Application 20060047051 A1. The solution is to include amorphous silica in the coating composition. However, a need still exits to provide for a low VOC coating composition that can be baked under low bake temperature conditions at reduced cycle time.

### SUMMARY

In an exemplary embodiment, multi-layer coating system includes:
a low bake temperature curable base coat coating comprising:
   a crosslinkable component comprising an acid functional acrylic copolymer polymerized from a monomer mixture comprising 2 percent to 12 percent of one or more carboxylic acid group containing monomers, percentages based on total weight of the acid functional acrylic copolymer,
   a crosslinking component; and
   a low bake temperature control agent comprising a rheology component chosen from an amorphous silica, a clay, or a combination thereof, the rheology component present in an amount of from about 0.1 to about 10 weight percent, and about 0.1 weight percent to about 10 weight percent of polyurea, said percentages based on total weight of the crosslinkable and crosslinking components; and
a clear coat coating composition comprising an acrylic copolymer component comprising one or more acrylic polymers, wherein the clear coat coating composition comprises primary hydroxyl and secondary hydroxyl groups at a ratio of about 30:70 to about 80:20, such as about 35:65 to about 75:25, such as about 40:60 to about 70:30, such as about 45:55 to about 70:30, such as about 50:50 to about 70:30, and wherein the clear coat coating composition overlies and is in contact with the low bake temperature curable base coat coating composition.

In another exemplary embodiment, a clear coat coating composition includes an acrylic copolymer component comprising one or more acrylic polymers, wherein the clear coat coating composition comprises primary hydroxyl and secondary hydroxyl groups at a ratio of about 30:70 to about 80:20, such as about 35:65 to about 75:25, such as about 40:60 to about 70:30, such as about 45:55 to about 70:30, such as about 50:50 to about 70:30.

In another exemplary embodiment, a process for producing a multi-layer coating on a substrate includes:
(a) mixing a cross-linkable component, a crosslinking component and a bake temperature control agent to form a base coat pot-mix, said crosslinkable component comprising an acid functional acrylic copolymer polymerized from a monomer mixture comprising about 2 weight percent to about 12 weight percent of carboxylic acid group containing monomer based on total weight of the acid functional acrylic copolymer, and wherein said bake temperature control agent comprises a rheology component chosen from an amorphous silica, a clay, or a combination thereof, the rheology component present in an amount of about 0.1 weight percent to about 10 weight percent, and about 0.1 weight percent to about 10 weight percent of polyurea, said percentages based on total weight of the crosslinkable and crosslinking components;
(b) applying a layer of said base coat pot-mix over said substrate;
(c) applying a layer of a clear coat coating composition disposed over and in contact with a layer of basecoat pot-mix to form a multi-layer coating composition, wherein said clear coat coating composition comprises an acrylic copolymer component comprising one or more acrylic polymers, wherein the clear coat coating composition comprises primary hydroxyl and secondary hydroxyl groups at a ratio of about 30:70 to about 80:20, such as about 35:65 to about 75:25, such as about 40:60 to about 70:30, such as about 45:55 to about 70:30, such as about 50:50 to about 70:30; and
(d) curing the multi-layer coating composition on said substrate.

### DETAILED DESCRIPTION

The features and advantages of the present invention will be more readily understood, by those of ordinary skill in the art, from reading the following detailed description. It is to be appreciated that certain features of the invention, which are, for clarity, described above and below in the context of separate embodiments, may also, be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

“Two-pack coating composition” means a thermoset coating composition having two components stored in separate containers. The containers containing the two components are typically sealed to increase their shelf life. The components are mixed just prior to use to form a pot mix, which has a limited pot life, typically ranging from a few minutes (15 minutes to 45 minutes) to a few hours (4 hours to 8 hours). The pot mix is applied as a layer of a desired thickness on a substrate surface, such as an auto body. After application, the layer dries and cures at low bake cure temperatures to form a coating on the substrate surface having desired coating properties, such as, high gloss, mar-resistance and resistance to environmental etching. Low bake cure temperature suitable for use herein range from about 60° F. (15° C.) to about 200° F. (93° C.). In one example, the low bake curing temperature is in a range of from about 60° F. (15° C.) to about 110° F. (43° C.), and is referred to as ambient temperatures or ambient conditions. In another example, the low bake curing temperature is in a range of from about 60° F. (15° C.) to about 140° F. (60° C.). In another example, the low bake curing temperature is in a range of from about 140° F. (60° C.) to about 160° F. (71° C.). In yet another example, the low bake curing temperature is in a range of from about 160° F. (71° C.) to about 200° F. (93° C.).

“Low VOC coating composition” means a coating composition that includes the range of from about 0.1 kilograms (1.0 pounds per gallon) to about 0.72 kilograms (6.0 pounds per gallon), preferably about 0.3 kilograms (2.6 pounds per gallon) to about 0.6 kilograms (5.0 pounds per gallon) and more preferably about 0.34 kilograms (2.8 pounds per gallon) to about 0.53 kilograms (4.4 pounds per gallon) of the solvent per liter of the coating composition. All VOC's determined under the procedure provided in ASTM D3960.

“High solids composition” means a coating composition having solid component of above about 30 percent, preferably in the range of from about 35 to about 90 percent and more preferably in the range of from about 40 to about 80 percent, all in weight percentages based on the total weight of the composition.

“GPC weight average molecular weight” means a weight average molecular weight measured by utilizing gel permeation chromatography. Measurements referred to herein were taken using a high performance liquid chromatograph (HPLC) supplied by Hewlett-Packard, Palo Alto, Calif. Unless stated otherwise, the liquid phase used was tetrahydrofuran and the standard was polymethyl methacrylate or polystyrene.

“Tg” (glass transition temperature) referred to herein is measured in ° C. determined by DSC (Differential Scanning Calorimetry).

“Polydispersity” means GPC weight average molecular weight divided by GPC number average molecular weight. The lower the polydispersity (closer to 1), the narrower will be the molecular weight distribution, which is desired.

“(Meth)acrylate” means acrylate and methacrylate.

“Polymer solids” means a polymer in its dry state.

“Crosslinkable component” means a component that includes a compound, polymer or copolymer having functional groups positioned in the backbone of the polymer, pendant from the backbone of the polymer, terminally positioned on the backbone of the polymer, or a combination thereof.

“Crosslinking component” is a component that includes a compound, polymer or copolymer having groups positioned in the backbone of the polymer, pendant from the backbone of the polymer, terminally positioned on the backbone of the polymer, or a combination thereof, wherein these groups are capable of crosslinking with the functional groups on the crosslinkable component (during the curing step) to produce a coating in the form of crosslinked structures.

In coating applications, especially the automotive refinish or OEM applications, a key driver is productivity, i.e., the ability of a layer of a coating composition to dry rapidly to a strike-in resistant state such that a subsequently coated layer, such as a layer formed from a clear coating composition does not adversely affect the underlying layer. Once the top layer is applied, the multi-coat system should then cure sufficiently rapidly without adversely affecting uniformity of color and appearance. The present invention addresses the forgoing issues by utilizing a unique crosslinking technology and an additive. Thus, the present coating composition includes a crosslinkable and crosslinking component.

The crosslinkable component includes about 2 weight percent to about 25 weight percent, preferably about 3 weight percent to about 20 weight percent, more preferably about 5 weight percent to about 15 weight percent of one or more acid functional acrylic copolymers, all percentages being based on the total weight of the crosslinkable component. If the composition contains excess of the upper limit of the acid functional acrylic copolymer, the resulting composition tends to have higher than required application viscosity. If the composition contains less than the lower limit of the acid functional copolymer, the resultant coating would have insignificant strike-in properties for a multi-coat system or flake orientation control in general.

The crosslinkable component includes an acid functional acrylic copolymer polymerized from a monomer mixture that includes about 2 weight percent to about 12 weight percent, preferably about 3 weight percent to about 10 weight percent, more preferably about 4 weight percent to about 6 weight percent of one or more carboxylic acid group containing monomers, all percentages being based on the total weight of the acid functional acrylic copolymer. If the amount of the carboxylic acid group-containing monomer in the monomer mixture exceeds the upper limit, the coatings resulting from such a coating composition would have unacceptable water sensitivity and if the amount is less than the lower limit, the resultant coating would have insignificant strike-in properties for a multi-coat system or flake orientation control in general.

The acid functional acrylic copolymer preferably has a GPC weight average molecular weight ranging from about 8,000 to about 100,000, preferably from about 10,000 to about 50,000 and more preferably from about 12,000 to about 30,000. The copolymer preferably has a polydispersity ranging from about 1.05 to about 10.0, preferably ranging from about 1.2 to about 8 and more preferably ranging from about 1.5 to about 5. The copolymer preferably has a Tg of ranging from about −5° C. to about +100° C., preferably from about 0° C. to about 80° C. and more preferably from about 10° C. to about 60° C.

The carboxylic acid group-containing monomers suitable for use in the present invention include (meth)acrylic acid, crotonic acid, oleic acid, cinnamic acid, glutaconic acid, muconic acid, undecylenic acid, itaconic acid, crotonic acid, fumaric acid, maleic acid, or a combination thereof. (Meth)acrylic acid preferred. It is understood that applicants also contemplate providing the acid functional acrylic copolymer with carboxylic acid groups by producing a copolymer polymerized from a monomer mixture that includes anhydrides of the aforementioned carboxylic acids and then hydrolyzing such copolymers to provide the resulting copolymer with carboxylic acid groups. Maleic and itaconic anhydrides are preferred. Applicants further contemplate hydrolyzing such anhydrides in them monomer mixture before the polymerization of the monomer mixture into the acid functional acrylic copolymer.

It is believed, without reliance thereon, that the presence of carboxylic acid groups in the copolymer of the present invention appears to increase viscosity of the resulting coating composition due to physical network formed by the well-known hydrogen bonding of carboxyl groups. As a result, such increased viscosity, assists in strike-in properties in multi-coat systems and flake orientation control in general.

The monomer mixture suitable for use in the present invention includes about 5 percent to about 40 percent, preferably about 10 percent to about 30 percent, all based on total weight of the acid functional acrylic copolymer of one or more functional (meth)acrylate monomers. It should be noted that if the amount of the functional (meth)acrylate monomers in the monomer mixture exceeds the upper limit, the pot life of the resulting coating composition is reduced and if less than the lower limit is used, it adversely affects the resulting coating properties, such as durability. The functional (meth)acrylate monomer is provided with one or more crosslinkable groups selected from a primary hydroxyl, secondary hydroxyl, or a combination thereof.

Some of suitable hydroxyl containing (meth)acrylate monomers have the following structure:

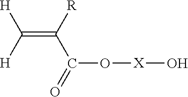

wherein R is H or methyl and X is a divalent moiety, which can be substituted or unsubstituted C₁ to C₁₈ linear aliphatic moiety, or substituted or unsubstituted C₃ to C₁₈ branched or cyclic aliphatic moiety. Some of the suitable substituents include nitrile, amide, halide, such as chloride, bromide, fluoride, acetyl, aceotoacetyl, hydroxyl, benzyl and aryl. Some specific hydroxyl containing (meth)acrylate monomers in the monomer mixture include 2-hydroxyethyl(meth)acrylate, 2-hydroxypropyl (meth)acrylate, 3-hydroxypropyl(meth)acrylate, and 4-hydroxybutyl(meth)acrylate.

The monomer mixture can also include one or more non-functional (meth)acrylate monomers. As used here, non-functional groups are those that do not crosslink with a crosslinking component. Some of suitable non-functional C1 to C20 alkyl(meth)acrylates include methyl(meth)acrylate, ethyl(meth)acrylate, propyl(meth)acrylate, butyl(meth)acrylate, pentyl(meth)acrylate, hexyl(meth)acrylate, octyl(meth)acrylate, nonyl(meth)acrylate, isodecyl(meth)acrylate, and lauryl(meth)acrylate; branched alkyl monomers, such as isobutyl(meth)acrylate, t-butyl(meth)acrylate and 2-ethylhexyl(meth)acrylate; and cyclic alkyl monomers, such as cyclohexyl(meth)acrylate, methylcyclohexyl(meth)acrylate, trimethylcyclohexyl(meth)acrylate, tertiarybutylcyclohexyl(meth)acrylate and isobornyl(meth)acrylate. Isobornyl(meth)acrylate and butyl acrylate are preferred.

The monomer mixture can also include one or more of other monomers for the purpose of achieving the desired properties, such as hardness, appearance and mar resistance. Some of the other such monomers include, for example, styrene, α-methyl styrene, acrylonitrile and methacrylonitrile. When included, preferably, the monomer mixture includes such monomers in the range of about 5 percent to about 30 percent, all percentages being in weight percent based on the total weight of the polymers solids. Styrene is preferred.

Any conventional bulk or solution polymerization process can be used to produce the acid functional acrylic copolymer of the present invention. One of the suitable processes for producing the copolymer of the present invention includes free radically solution polymerizing the aforedescribed monomer mixture.

The polymerization of the monomer mixture can be initiated by adding conventional thermal initiators, such as azos exemplified by Vazo® 64 supplied by DuPont Company, Wilmington, Del.; and peroxides, such as t-butyl peroxy acetate. The molecular weight of the resulting copolymer can be controlled by adjusting the reaction temperature, the choice and the amount of the initiator used, as practiced by those skilled in the art.

The crosslinking component of the present invention includes one or more polyisocyanates, melamines, or a combination thereof. Polyisocyanates are preferred.

Typically, the polyisocyanate is provided with in the range of about 2 to about 10, preferably about 2.5 to about 8, more preferably about 3 to about 5 isocyanate functionalities. Generally, the ratio of equivalents of isocyanate functionalities on the polyisocyanate per equivalent of all of the functional groups present in the crosslinking component ranges from about 0.5/1 to about 3.0/1, preferably from about 0.7/1 to about 1.8/1, more preferably from about 0.8/1 to about 1.3/1. Some suitable polyisocyanates include aromatic, aliphatic, or cycloaliphatic polyisocyanates, trifunctional polyisocyanates and isocyanate functional adducts of a polyol and difunctional isocyanates. Some of the particular polyisocyanates include diisocyanates, such as 1,6-hexamethylene diisocyanate, isophorone diisocyanate, 4,4′-biphenylene diisocyanate, toluene diisocyanate, biscyclohexyl diisocyanate, tetramethylene xylene diisocyanate, ethyl ethylene diisocyanate, 1-methyltrimethylene diisocyanate, 1,3-phenylene diisocyanate, 1,5-napthalene diisocyanate, bis-(4-isocyanatocyclohexyl)-methane and 4,4′-diisocyanatodiphenyl ether.

Some of the suitable trifunctional polyisocyanates include triphenylmethane triisocyanate, 1,3,5-benzene triisocyanate, and 2,4,6-toluene triisocyanate. Trimers of diisocyanate, such as the trimer of hexamethylene diisocyanate sold under the trademark Desmodur®N-3390 by Bayer Corporation of Pittsburgh, Pa. and the trimer of isophorone diisocyanate are also suitable. Furthermore, trifunctional adducts of triols and diisocyanates are also suitable. Trimers of diisocyanates are preferred and trimers of isophorone and hexamethylene diisocyanates are more preferred.

Typically, the coating composition can include about 0.1 weight percent to about 40 weight percent, preferably, about 15 weight percent to about 35 weight percent, and more preferably about 20 weight percent to about 30 weight percent of the melamine, wherein the percentages are based on total weight of composition solids.

Some of the suitable melamines include monomeric melamine, polymeric melamine-formaldehyde resin or a combination thereof. The monomeric melamines include low molecular weight melamines which contain, on an average, three or more methylol groups etherized with a C1 to C5 monohydric alcohol such as methanol, n-butanol, or isobutanol per triazine nucleus, and have an average degree of condensation up to about 2 and preferably in the range of about 1.1 to about 1.8, and have a proportion of mononuclear species not less than about 50 percent by weight. By contrast the polymeric melamines have an average degree of condensation of more than about 1.9. Some such suitable monomeric melamines include alkylated melamines, such as methylated, butylated, isobutylated melamines and mixtures thereof. Many of these suitable monomeric melamines are supplied commercially. For example, Cytec Industries Inc., West Patterson, N.J. supplies Cymel® 301 (degree of polymerization of 1.5, 95% methyl and 5% methylol), Cymel® 350 (degree of polymerization of 1.6, 84% methyl and 16% methylol), 303, 325, 327, 370 and XW3106, which are all monomeric melamines Suitable polymeric melamines include high amino (partially alkylated, —N, —H) melamine known as Resimene® BMP5503 (molecular weight 690, polydispersity of 1.98, 56% butyl, 44% amino), which is supplied by Solutia Inc., St. Louis, Mo., or Cymel®1158 provided by Cytec Industries Inc., West Patterson, N.J. Cytec Industries Inc. also supplies Cymel® 1130@80 percent solids (degree of polymerization of 2.5), Cymel® 1133 (48% methyl, 4% methylol and 48% butyl), both of which are polymeric melamines

If desired, including appropriate catalysts in the crosslinkable component can accelerate the curing process of a potmix of the coating composition.

When the crosslinking component includes polyisocyanate, the crosslinkable component of the coating composition preferably includes a catalytically active amount of one or more catalysts for accelerating the curing process. Generally, a catalytically active amount of the catalyst in the coating composition ranges from about 0.001 percent to about 5 percent, preferably ranges from about 0.005 percent to about 2 percent, more preferably ranges from about 0.01 percent to about 1 percent, all in weight percent based on the total weight of crosslinkable and crosslinking component solids. A wide variety of catalysts can be used, such as, tin compounds, including dibutyl tin dilaurate and dibutyl tin diacetate; tertiary amines, such as, triethylenediamine These catalysts can be used alone or in conjunction with carboxylic acids, such as, acetic acid. One of the commercially available catalysts, sold under the trademark, Fastcat® 4202 dibutyl tin dilaurate by Arkema North America, Inc. Philadelphia, Pa., is particularly suitable.

When the crosslinking component includes melamine, it also preferably includes a catalytically active amount of one or more acid catalysts to further enhance the crosslinking of the components on curing. Generally, the catalytically active amount of the acid catalyst in the coating composition ranges from about 0.1 percent to about 5 percent, preferably ranges from about 0.1 percent to about 2 percent, more preferably ranges from about 0.5 percent to about 1.2 percent, all in weight percent based on the total weight of crosslinkable and crosslinking component solids. Some suitable acid catalysts include aromatic sulfonic acids, such as dodecylbenzene sulfonic acid, para-toluenesulfonic acid and dinonylnaphthalene sulfonic acid, all of which are either unblocked or blocked with an amine, such as dimethyl oxazolidine and 2-amino-2-methyl-1-propanol, n,n-dimethylethanolamine or a combination thereof. Other acid catalysts that can be used are strong acids, such as phosphoric acids, more particularly phenyl acid phosphate, which may be unblocked or blocked with an amine.

The crosslinkable component of the coating composition can further include in the range of from about 0.1 percent to about 95 percent, preferably in the range of from about 10 percent to about 90 percent, more preferably in the range of from about 20 percent to about 80 percent and most preferably in the range of about 30 percent to about 70 percent, all based on the total weight of the crosslinkable component of an acrylic polymer, a polyester or a combination thereof. Applicants have discovered that by adding one or more the foregoing polymers to the crosslinkable component, the coating composition resulting therefrom provides coating with improved sag resistance, and flow and leveling properties.

The acrylic polymer suitable for use in the present invention can have a GPC weight average molecular weight exceeding 2000, preferably in the range of from about 3000 to about 20,000, and more preferably in the range of about 4000 to about 10,000. The Tg of the acrylic polymer varies in the range of from 0° C. to about 100° C., preferably in the range of from about 10° C. to about 80° C.

The acrylic polymer suitable for use in the present invention can be conventionally polymerized from typical monomers, such as alkyl(meth)acrylates having alkyl carbon atoms in the range of from 1 to 18, preferably in the range of from 1 to 12 and styrene and functional monomers, such as, hydroxyethyl acrylate and hydroxyethyl methacrylate.

The polyester suitable for use in the present invention can have a GPC weight average molecular weight exceeding 1500, preferably in the range of from about 1500 to about 100,000, more preferably in the range of about 2000 to about 50,000, still more preferably in the range of about 2000 to about 8000 and most preferably in the range of from about 2000 to about 5000. The Tg of the polyester varies in the range of from about −50° C. to about +100° C., preferably in the range of from about −20° C. to about +50° C.

The polyester suitable for use in the present invention can be conventionally polymerized from suitable polyacids, including cycloaliphatic polycarboxylic acids, and suitable polyols, which include polyhydric alcohols. Examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic and cyclobutanetetracarboxylic acid. The cycloaliphatic polycarboxylic acids can be used not only in their cis but also in their trans form and as a mixture of both forms. Examples of suitable polycarboxylic acids, which, if desired, can be used together with the cycloaliphatic polycarboxylic acids, are aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid.

Suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, tris(hydroxyethyl) isocyanate, polyethylene glycol and polypropylene glycol. If desired, monohydric alcohols, such as, for example, butanol, octanol, lauryl alcohol, ethoxylated or propoxylated phenols may also be included along with polyhydric alcohols. The details of polyester suitable for use in the present invention are further provided in the U.S. Pat. No. 5,326,820, which is hereby incorporated herein by reference. One commercially available polyester, which is particularly preferred, is SCD®-1040 polyester, which is supplied by Etna Product Inc., Chagrin Falls, Ohio.

The crosslinkable component can further include one or more reactive oligomers, such as those reactive oligomers disclosed in U.S. Pat. No. 6,221,494, which are incorporated herein by reference; and non-alicyclic (linear or aromatic) oligomers, if desired. Such non-alicyclic-oligomers can be made by using non-alicyclic anhydrides, such as succinic or phthalic anhydrides, or mixtures thereof. Caprolactone oligomers described in U.S. Pat. No. 5,286,782 incorporated herein by reference can also be used.

The crosslinkable component of the coating composition can further include one or more modifying resins, which are also known as non-aqueous dispersions (NADs). Such resins are sometimes used to adjust the viscosity of the resulting coating composition. The amount of modifying resin that can be used typically ranges from about 10 percent to about 50 percent, all percentages being based on the total weight of crosslinkable component solids. The weight average molecular weight of the modifying resin generally ranges from about 20,000 to about 100,000, preferably ranges from about 25,000 to about 80,000 and more preferably ranges from about 30,000 to about 50,000.

The crosslinkable or crosslinking component of coating composition of the present invention, typically contains at least one organic solvent which is typically selected from the group consisting of aromatic hydrocarbons, such as, petroleum naphtha or xylenes; ketones, such as, methyl amyl ketone, methyl isobutyl ketone, methyl ethyl ketone or acetone; esters, such as, butyl acetate or hexyl acetate; and glycol ether esters, such as propylene glycol monomethyl ether acetate. The amount of organic solvent added depends upon the desired solids level as well as the desired amount of VOC of the composition. If desired, the organic solvent may be added to both components of the binder. High solids and low VOC coating composition is preferred.

Applicants have made a surprise discovery that when the following low bake temperature control agent is included with either the crosslinkable component, the crosslinking component, or both of the coating composition (preferably with the crosslinkable component), the sag resistance of the layer applied over a substrate surface can be improved under the low bake temperature condition, which is the desired outcome of the present invention. The low bake temperature control agent of the present invention includes a rheology component. In an exemplary embodiment, the rheology component includes an amorphous silica, a clay, or a combination of both. In another exemplary embodiment, the low bake temperature control agent includes about 0.1 weight percent to about 10 weight percent, preferably about 0.3 weight percent to about 5 weight percent, more preferably about 0.5 weight percent to about 2 weight percent of the rheology component, and in the range of about 0.1 weight percent to about 10 weight percent, preferably in the range of about 0.3 weight percent to about 5 weight percent and more preferably in the range of about 0.5 weight percent to about 2 weight percent of polyurea, the weight percentages being based on total weight of the crosslinkable and crosslinking components of the low bake curable coating composition of the present invention. If too little silica and polyurea are used (less than the aforecited ranges) no advantage can be seen and if too much silica and polyurea are used (more than the aforecited ranges), the resulting coating surface becomes rough.

The amorphous silica suitable for use in the present invention includes colloidal silica, which has been partially, or totally surface modified through the silanization of hydroxyl groups on the silica particle, thereby rendering part or all of the silica particle surface hydrophobic. Examples of suitable hydrophobic silica include AEROSIL R972, AEROSIL R812, AEROSIL OK412, AEROSIL TS-100 and AEROSIL R805, all commercially available from Evonik Industries AG, Essen, Germany. Particularly preferred fumed silica is available from Evonik Industries AG, Essen, Germany as AEROSIL R 812. Other commercially available silica include SIBELITE® M3000 (Cristobalite), SIL-CO-SIL®, ground silica, MIN-U-SIL®, micronized silica, all supplied by U.S. Silica Company, Berkeley Springs, W. Va.

The silica can be dispersed in the copolymer by a milling process using conventional equipment such as high-speed blade mixers, ball mills, or sand mills. Preferably, the silica is dispersed separately in the acrylic polymer described earlier and then the dispersion can be added to the crosslinkable component of the coating composition.

The clay suitable for use herein can include clay, dispersed clay, or a combination thereof. Examples of commercially available clay products include bentonite clay available as BENTONE® from Elementis Specialties, London, United Kingdom, and GARAMITE® clay available from Southern Clay Products, Gonzales, Tex., USA, under respective registered trademarks. BENTONE® 34 dispersion described in U.S. Pat. No. 8,357,456 and GARAMITE® dispersion described in U.S. Pat. No. 8,227,544, and a combination of the two are suitable. A combination of the silica and the clay such as the aforementioned BENTONE®, the GARAMITE®, or dispersions thereof, also can be used.

The polyurea suitable for use in the low bake temperature control agent is obtained from polymerization of a monomer mixture that includes about 0.5 to about 3 weight percent of the amine monomers, about 0.5 to about 3 weight percent of the isocyanate monomers, and about 94 to about 99 weight percent of a moderating polymer. The amine monomer is selected from the group consists of a primary amine, secondary amine, ketimine, aldimine, or a combination thereof. Benzyl amine is preferred. The isocyanate monomer is selected from the group consisting of an aliphatic polyisocyanate, cycloaliphatic polyisocyanate, aromatic polyisocyanate and a combination thereof. The preferred isocyanate monomer is 1,6 hexamethylene diisocyanate. The moderating polymer can be one or more of the aforedescribed polymers. The acrylic polymers or polyesters are preferred.

Preferably, the polyurea is produced by mixing one or more of the moderating polymers with the amine monomers and then isocyanate monomers are added over time under ambient conditions.

The sag resistance of a layer from a pot mix resulting from mixing of the crosslinkable and crosslinking components of the current coating composition when applied over a substrate is in the range of from about 5 (127 Micrometers) to about 20 mils (508 micrometers), as measured under ASTM test D4400-99. The higher the number, the higher will be the desired sag resistance.

The coating composition is preferably formulated as a two-pack coating composition wherein the crosslinkable component is stored in a separate container from the crosslinking component, which is mixed to form a pot mix just before use.

The coating composition is preferably formulated as an automotive OEM composition or as an automotive refinish composition. These compositions can be applied as a basecoat or as a pigmented monocoat topcoat over a substrate. These compositions require the presence of pigments. Typically, a pigment-to-binder ratio of about 1.0/100 to about 200/100 is used depending on the color and type of pigment used. The pigments are formulated into mill bases by conventional procedures, such as, grinding, sand milling, and high speed mixing. Generally, the mill base comprises pigment and a dispersant in an organic solvent. The mill base is added in an appropriate amount to the coating composition with mixing to form a pigmented coating composition.

Any of the conventionally used organic and inorganic pigments, such as white pigments, for example, titanium dioxide, color pigments, metallic flakes, for example, aluminum flakes, special effects pigments, for example, coated mica flakes and coated aluminum flakes, and extender pigments can be used.

The coating composition can also include other conventional formulation additives, such as wetting agents, leveling and flow control agents, for example, Resiflow® S (polybutylacrylate), BYK® 320 and 325 (high molecular weight polyacrylates), BYK® 347 (polyether-modified siloxane), defoamers, surfactants and emulsifiers to help stabilize the composition. Other additives that tend to improve mar resistance can be added, such as, silsesquioxanes and other silicate-based micro-particles.

To improve weatherability of the clear finish of the coating composition, about 0.1% to about 5% by weight, based on the weight of the composition solids, of an ultraviolet light stabilizer or a combination of ultraviolet light stabilizers and absorbers can be added. These stabilizers include ultraviolet light absorbers, screeners, quenchers and specific hindered amine light stabilizers. Also, about 0.1% to about 5% by weight, based on the weight of the composition solids, of an antioxidant can be also added. Most of the foregoing stabilizers are supplied by BASF, Florham Park, N.J.

The coating composition of the present invention is preferably formulated in the form of a two-pack coating composition. The present invention is particularly useful as a basecoat for outdoor articles, such as automobile and other vehicle body parts. A typical auto or truck body is produced from a steel sheet or a plastic or a composite substrate. For example, the fenders may be of plastic or a composite and the main portion of the body of steel. If steel is used, it is first treated with an inorganic rust-proofing compound, such as, zinc or iron phosphate, called an E-coat and then a primer coating is applied generally by electrodeposition. Typically, these electrodeposition primers are epoxy-modified resins crosslinked with a polyisocyanate and are applied by a cathodic electrodeposition process. Optionally, a primer can be applied over the electrodeposited primer, usually by spraying, to provide better appearance and/or improved adhesion of a base coating or a mono coating to the primer.

The present invention is also directed to a process for producing a multi-coat system on a substrate. The process includes the following process steps:

The cross-linkable component of the aforedescribed coating composition of the present invention is mixed with the crosslinking component of the coating composition to form a pot-mix. Generally, the crosslinkable component and the crosslinking component are mixed just prior to application to form a pot mix. The mixing can take place though a conventional mixing nozzle or separately in a container.

A layer of the pot mix generally having a thickness in the range of about 15 micrometers to about 200 micrometers is applied over a substrate, such as an automotive body or an automotive body that has precoated with a conventional E-coat followed by a conventional primer, or a conventional primer. The foregoing application step can be conventionally accomplished by spraying, electrostatic spraying, commercially supplied robot spraying system, roller coating, dipping, flow coating or brushing the pot mix over the substrate. The layer after application is flashed, i.e., exposed to air, to reduce the solvent content from the potmix layer to produce a strike-in resistant layer. The time period of the flashing step ranges from about 5 to about 15 minutes.

In some embodiments, one or more layers of a conventional clear coat coating composition having a thickness in the range of about 15 micrometers to about 200 micrometers is conventionally applied by the application means described earlier over the strike-in resistant layer to form a multi-layer system on the substrate. As with application of multiple layers of basecoat, a period of flash time, such as about 60-120 seconds, may pass between applying a first and second layer of clear coat. Any suitable conventional clear coating compositions can be used in the multi-coat system of the present invention. For example, suitable clear coats for use over the basecoat of this invention include solvent borne organosilane polymer containing clear coating composition disclosed U.S. Pat. No. 5,244,696; solvent borne polyisocyanate crosslinked clear coating composition, disclosed in U.S. Pat. No. 6,433,085; clear thermosetting compositions containing epoxy-functional polymers disclosed in U.S. Pat. No. 6,485788; wherein all of the forgoing patents are hereby incorporated herein by reference.

Some embodiments described herein utilize a crosslinkable clear coat coating composition comprising an acrylic copolymer (i.e., an acrylic resin) polymerized from a monomer mixture that includes ethylenically unsaturated monomers containing hydroxyl functionality. The clear coat coating composition of this disclosure can comprise one or more acrylic copolymers have primary hydroxyl groups and secondary hydroxyl groups. In one example, the acrylic copolymers can comprise an acrylic polymer polymerized from a monomer mixture comprising a first acrylic monomer comprising a primary hydroxyl group and a second acrylic monomer comprising a secondary hydroxyl group. In another example, the acrylic copolymers can comprise an acrylic polymer comprising both primary hydroxyl groups and secondary hydroxyl groups. In yet another example, a mixture of polymers having primary and secondary hydroxyl groups can also be suitable. A polymer comprising primary hydroxyl groups can be polymerized from monomers having primary hydroxyl groups. A polymer comprising secondary hydroxyl groups can be polymerized from monomers having secondary hydroxyl groups. A polymer comprising both primary and secondary hydroxyl groups can be polymerized from a monomer mixture comprising monomers having primary hydroxyl groups and monomers having secondary hydroxyl groups. Monomer isoforms having mixed primary and secondary hydroxyl groups can also be suitable. The ratio of primary and secondary hydroxyl groups of the clear coating composition can be adjusted by polymerizing acrylic polymers from predetermined ratio of monomers having the primary and secondary hydroxyl group in one example, mixing predetermined amounts of one or more polymers having the primary hydroxyl groups with one or more polymers having the secondary hydroxyl groups in another example, or a combination thereof.

Ethylenically unsaturated monomers containing hydroxy functionality include hydroxy alkyl acrylates and hydroxy alkyl methacrylates, wherein the alkyl group has 1 to 4 carbon atoms. Suitable monomers include hydroxy ethyl acrylate, hydroxy propyl acrylate, hydroxy isopropyl acrylate, hydroxy butyl acrylate, hydroxy ethyl methacrylate, hydroxy propyl methacrylate, hydroxy isopropyl methacrylate, hydroxy butyl methacrylate, and the like, and mixtures thereof. In some embodiments, the clear coat coating composition comprises primary hydroxyl groups and secondary hydroxyl groups at a ratio of about 30:70 to about 80:20, such as about 35:65 to about 75:25, such as about 40:60 to about 70:30, such as about 45:55 to about 70:30, such as about 50:50 to about 70:30, such as about 55:65 to about 70:30, such as about 60:40 to about 70:30, such as about 65:35 to about 70:30.

In some embodiments, the acrylic copolymer component of the clear coat coating composition comprises a single acrylic resin. In alternate embodiments, the acrylic copolymer component comprises a plurality of acrylic resins. In some embodiments, the acrylic copolymer component comprises an acrylic resin with a Tg (theoretical) of about 45° C. to about 95° C., such as about 55° C. to about 85° C., such as about 65° C. to about 75° C. It will be appreciated that in embodiments where the acrylic copolymer component comprises a plurality of acrylic resins, the types and relative amounts of monomers present in each acrylic resin may be selected such that cumulatively the primary hydroxyl and secondary hydroxyl groups in the clear coat coating composition are at a ratio of about 30:70 to about 80:20, such as about 35:65 to about 75:25, such as about 40:60 to about 70:30, such as about 45:55 to about 70:30, such as about 50:50 to about 70:30, such as about 55:65 to about 70:30, such as about 60:40 to about 70:30, such as about 65:35 to about 70:30. In some embodiments where the acrylic copolymer component comprises a plurality of acrylic resins, the acrylic copolymer component comprises a first acrylic resin with a ratio of primary to secondary hydroxyl groups of about 45:55 to about 80:20. In some embodiments where the acrylic copolymer component comprises a plurality of acrylic resins, the acrylic copolymer component comprises an acrylic resin with a Tg (theoretical) of about 25° C. to about 95° C., such as about 55° C. to about 85° C., such as about 65° C. to about 75° C.

The multi-layer system is then cured into said multi-coat system under low bake temperatures. Under typical automotive OEM applications, the multi-layer system can be typically cured at low bake temperatures in about 10 to about 60 minutes. It is further understood that the actual curing time can depend upon the thickness of the applied layer, the cure temperature, humidity and on any additional mechanical aids, such as fans, that assist in continuously flowing air over the coated substrate to accelerate the cure rate. It is understood that actual curing temperature would vary depending upon the catalyst and the amount thereof, thickness of the layer being cured and the amount of the crosslinking component utilized. For example, the curing step can be accelerating by adding a catalytically active amount of a catalyst or acid catalyst to the composition.

It has surprisingly been found that certain combinations of basecoat and clear coat, such as those combinations which include a basecoat as described herein and a clear coat coating composition comprising primary hydroxyl groups and secondary hydroxyl groups at a ratio of about 30:70 to about 80:20, such as about 35:65 to about 75:25, such as about 40:60 to about 70:30, such as about 45:55 to about 70:30, such as about 50:50 to about 70:30, such as about 55:65 to about 70:30, such as about 60:40 to about 70:30, such as about 65:35 to about 70:30, beneficially interact to provide a multi-layer coating with improved characteristics. In embodiments, a basecoat/clear coat multi-layer system may be cured under appropriate conditions, such as about 160° F. for an appropriate period of time, such as about 20 minutes, to result in a hard dry film. In particular, some multi-layer system as described herein exhibited an R value (orange peel) less than 6, such as about 4 to about 6, for a dry film thickness of 1.5 mils (as measured by ASTM D3451). In some embodiments, some multi-layer compositions as described herein exhibited a distinctness of image (DOI) value of greater than about 85 (e.g., about 85 to about 95), such as greater than about 89 (e.g., about 89 to about 95), for a film thickness of 1.5 mils (as measured by ASTM D5767). In some embodiments, some multi-layer compositions as described herein exhibited gloss values of at least about 88 (e.g., about 88 to about 95) at 20° and at least about 90 (e.g., about 90 to about 99) at 60° , for a dry film thickness of about 1.8 mils. In some embodiments, some multi-layer compositions as described herein exhibited a short wave value of a wave scan of less than about 30 (e.g., about 30 to about 25), such as less than about 27 (e.g., about 27 to about 25) for a dry film of 1.8 mils. The base coat clear

It should be noted that if desired the present invention also includes a method of applying one or more layers of the aforedescribed base coat pot-mix, followed by applying one or more layers of the aforedescribed clear coat composition (i.e., a clear coat composition with primary hydroxyl groups and secondary hydroxyl groups at a ratio of about 30:70 to about 80:20, such as about 35:65 to about 75:25, such as about 40:60 to about 70:30, such as about 45:55 to about 70:30, such as about 50:50 to about 70:30, such as about 55:65 to about 70:30, such as about 60:40 to about 70:30, such as about 65:35 to about 70:30), which is then cured to produce a multi-layer coating on a substrate that may or may not include other previously applied coatings, such as an E-coat or a primer coat.

The suitable substrates for applying the coating composition of the present invention include automobile bodies, any and all items manufactured and painted by automobile sub-suppliers, frame rails, commercial trucks and heavy duty truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, pleasure vehicles, pleasure craft snow mobiles, all-terrain vehicles, personal watercraft, motorcycles, boats, and aircraft. The substrate further includes industrial and commercial new construction and maintenance thereof; cement and wood floors; leather; walls of commercial and residential structures, such office buildings and homes; amusement park equipment; concrete surfaces, such as parking lots and drive ways; asphalt and concrete road surface, wood substrates, marine surfaces; outdoor structures, such as bridges, towers; coil coating; railroad cars; printed circuit boards; machinery; OEM tools; signage; fiberglass structures; sporting goods; and sporting equipment.

### EXAMPLES

### Test Procedures

Sag Resistance: Sag resistance was measured by using ASTM test D4400-99.

Distinctness of Image (DOI): DOI was measured using a Hunterlab Model RS 232 (HunterLab, Reston, Va.).

Surface roughness: Orange Peel (R) of base coat dry film was measured by using ASTM D3451.

### Procedure 1: Preparation of Acrylic Polymers

Acrylic polymers were formed by similar free-radical copolymerization as described above with different monomer ratios as described below. A reactor equipped with a stirrer, reflux condenser and under nitrogen, was charged with 13.7 parts t-butylacetate and heated to reflux at approximately 96° C. A monomer mixture of 14.6 parts by weight of methyl methacrylate, 5.9 parts by weight of styrene, 11.7 parts by weight of hydroxyethyl methacrylate, 14.6 parts by weight of n-butyl acrylate, 11.7 parts by weight of 2-ethylhexyl methacrylate, and 1.2 parts by weight of t-butylacetate was premixed. An initiator mixture of 3.4 parts Vazo®67 thermal initiator (Vazo®67 is available from E.I. DuPont de Nemours and Company, Wilmington, Del., USA) and 23.2 parts t-butylacetate was premixed. The monomer mixture was fed over 360 minutes at reflux simultaneously with the initiator mixture. The initiator mixture was further fed over 390 minutes. After the initiator mixture feed was complete, the reaction mixture was held for 60 minutes at reflux and then cooled to room temperature.

The resulting acrylic polymer produced herein had the following characteristics: a calculated Tg of +17.6° C., solids 60%, Gardner-Holdt viscosity Y+1/4, and weight average molecular weight (Mw) of 10,000.

### Procedure 2: Preparation of Polyurea

In a reactor, 1.7 parts by weight percent of benzyl amine (available from BASF, Florham Park, N.J.) was added to 1.34 parts by weight percent of 1,6 Hexamethylene Diiscocyanate, in the presence of 96.36 parts by weight percent of the acrylic polymer (Tg=17.6° C.) from Procedure 1. The mixture was stirred for 5 minutes to produce the polyurea.

### Procedure 3: Preparation of Low Bake Temperature Control Agent

In a conventional milling device, 9 parts by weight percent of Aerosil® R 805 fumed silica powder supplied by Evonik Industries AG, Essen, Germany was milled with 30 parts by weight percent of the acrylic polymer from Procedure 1 and 61 parts by weight percent of butyl acetate to a fineness of 7.5 to 8.0 as measured on a Hegman gauge. Then, 50 parts by weight percent of this silica dispersion was let down with 50 parts by weight percent of the polyurea from Procedure 2 to produce the low bake temperature control agent of the present invention. The BENOTONE® dispersion, GARAMITE® dispersion, or a combination thereof can also be let down at 50 parts by weight percent with 50 parts by weight of the polyuria. A combination of the silica dispersion, BENTONE® dispersion, and GARAMITE® dispersion can also be used.

Tables below show the formulations of the comparative examples and an example of the present invention:

TABLE 1
Coating System of Comparative Example 1
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 30 minutes at high bake temperature of 180° F. (82.2° C.)]

| Base Coat Ingredients | In grams |
|---|---|
| Polyurea binder prepared by Procedure 2 | 0 |
| Low bake temperature control agent | 0 |
| prepared by Procedure 3 | |
| Silica dispersion⁽¹⁾ | 0 |
| Acid functional acrylic copolymer ⁽²⁾ | 250 |
| Polyester ⁽³⁾ | 197 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1051 |

Test Results

| | |
|---|---|
| Basecoat Sag dry film thickness | 2 mils (50.8 microns) |
| R (orange peel) at BC dry film | 5 |
| thickness of 1.5 mils (38.1 microns) | |
| measured by ASTM D3451 | |
| DOI at Base Coat dry film thickness of | 65 |
| 1.5 mils (38.1 microns) measured by | |
| ASTM D5767 | |
| Test Observations | weak sag resistance |

Unless stated otherwise, all the ingredients were supplied by Axalta Coating Systems, LLC of Wilmington, Delaware.
Note:
⁽¹⁾The silica dispersion was prepared according to US Patent Publication 2006/0047051, Table 6, [0080]-[0081], herein incorporated by reference.
⁽²⁾ The acid functional acrylic copolymer was prepared according to Acid Functional Acrylic Copolymer 2: styrene/butyl acrylate/2-ethylhexyl acrylate/isobornyl acrylate/hydroxypropyl methacrylate/2-hydroxyethyl mathacrylate/methacrylaic acid: 15.0/30.0/20.0/15.0/7.5/7.5/5.0% by weight. The resulting polymer solution was clear and had a solid content of about 65.5% and a Gardner-Holt viscosity of W-1/2. The polymer had a GPC Mw of 15,049 and GPC Mn of 4,789 based on GPC using polystyrene as the standard and a Tg of +3.7° C. as measured by DSC, as described in US Patent Publication No. 2006/0047051 A1, herein incorporated by reference.
⁽³⁾ Polyester was prepared according to US Patent Publication 2006/0047051, Table 5, [0078]-[0079], herein incorporated by reference.

TABLE 2
Coating System of Comparative Example 2
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 30 minutes at high bake temperature of 180° F. (82.2° C.)]

| Base Coat Ingredients | In grams |
|---|---|
| Polyurea binder prepared by Procedure 2 | 0 |
| Low bake temperature control agent | 0 |
| prepared by Procedure 3 | |
| Silica dispersion(1) | 224 |
| Acid functional acrylic copolymer (2) | 76 |
| Polyester (3) | 146 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1049 |

Test Results

| | |
|---|---|
| Basecoat Sag dry film thickness | 4 mils (101.6 microns) |
| R (orange peel) at BC dry film | 5 |
| thickness of 1.5 mils (38.1 microns) | |
| measured by ASTM D3451 | |
| DOI at Base Coat dry film | 75 |
| thickness of 1.5 mils (38.1 microns) | |
| measured by ASTM D5767 | |
| Test Observations | good sag resistance |
| | and very smooth |
| | and good DOI |

Unless stated otherwise, all the ingredients were supplied by Axalta Coating Systems, LLC of Wilmington, Delaware.
Note:
(1)-(3) same as in Table 1.

TABLE 3
Coating System of Comparative Example 3
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 30 minutes at high bake temperature of 180° F. (82.2° C.)]

| Base Coat Ingredients | In grams |
|---|---|
| Polyurea binder prepared by Procedure 2 | 400 |
| Low bake temperature control agent | 0 |
| prepared by Procedure 3 | |
| Silica dispersion(1) | 0 |
| Acid functional acrylic copolymer (2) | 0 |
| Polyester (3) | 50 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1054 |

Test Results

| | |
|---|---|
| Basecoat Sag dry film thickness | 3 mils (76.2 microns) |
| R (orange peel) at BC dry film | 6 |
| thickness of 1.5 mils (38.1 microns) | |
| measured by ASTM D3451 | |
| DOI at Base Coat dry film | 78 |
| thickness of 1.5 mils (38.1 microns) | |
| measured by ASTM D5767 | |
| Test Observations | good sag resistance |
| | and very smooth |
| | and good DOI |

Unless stated otherwise, all the ingredients were supplied by Axalta Coating Systems, LLC of Wilmington, Delaware.
Note:
(1)-(3) same as in Table 1.

TABLE 4
Coating System of Comparative Example 4
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 20 minutes at low bake temperature of 160° F. (71.1° C.)]

| Base Coat Ingredients | In grams |
|---|---|
| Polyurea binder prepared by Procedure 2 | 0 |
| Low bake temperature control agent | 0 |
| prepared by Procedure 3 | |
| Silica dispersion(1) | 0 |
| Acid functional acrylic copolymer (2) | 250 |
| Polyester (3) | 197 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1051 |

Test Results

| | |
|---|---|
| Basecoat Sag dry film thickness | 1 mil (25.4 microns) |
| R (orange peel) at BC dry film | 4 |
| thickness of 1.5 mils (38.1 microns) | |
| measured by ASTM D3451 | |
| DOI at Base Coat dry film | 50 |
| thickness of 1.5 mils (38.1 microns) | |
| measured by ASTM D5767 | |
| Test Observations | weak sag resistance |
| | and reduction in DOI |

Unless stated otherwise, all the ingredients were supplied by Axalta Coating Systems, LLC of Wilmington, Delaware.

TABLE 5
Coating System of Comparative Example 5
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 20 minutes at low bake temperature of 160° F. (71.1° C.)]

| Base Coat Ingredients | In grams |
|---|---|
| Polyurea binder prepared by Procedure 2 | 0 |
| Low bake temperature control agent | 0 |
| prepared by Procedure 3 | |
| Silica dispersion⁽¹⁾ | 224 |
| Acid functional acrylic copolymer ⁽²⁾ | 76 |
| Polyester ⁽³⁾ | 146 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1049 |

Test Results

| | |
|---|---|
| Basecoat Sag dry film thickness | 4 mils (101.6 microns) |
| R (orange peel) at BC dry film | 3 |
| thickness of 1.5 mils (38.1 microns) | |
| measured by ASTM D3451 | |
| DOI at Base Coat dry film | 61 |
| thickness of 1.5 mils (38.1 microns) | |
| measured by ASTM D5767 | |
| Test Observations | good sag resistance, |
| | but peely |

Unless stated otherwise, all the ingredients were supplied by Axalta Coating Systems, LLC of Wilmington, Delaware.
Note:
⁽¹⁾⁻⁽³⁾ same as in Table 1.

TABLE 6
Coating System of Comparative Example 6
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 20 minutes at low bake temperature of 160° F. (71.1° C.)]

| Base Coat Ingredients | In grams |
|---|---|
| Polyurea binder prepared by Procedure 2 | 400 |
| Low bake temperature control agent | 0 |
| prepared by Procedure 3 | |
| Silica dispersion⁽¹⁾ | 0 |
| Acid functional acrylic copolymer ⁽²⁾ | 0 |
| Polyester ⁽³⁾ | 50 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1054 |

Test Results

| | |
|---|---|
| Basecoat Sag dry film thickness | 2 mils (50.8 microns) |
| R (orange peel) at BC dry film | 5 |
| thickness of 1.5 mils (38.1 microns) | |
| measured by ASTM D3451 | |
| DOI at Base Coat dry film | 65 |
| thickness of 1.5 mils (38.1 microns) | |
| measured by ASTM D5767 | |
| Test Observations | medium sag resistance |
| | and smooth |

Unless stated otherwise, all the ingredients were supplied by Axalta Coating Systems, LLC of Wilmington, Delaware.

TABLE 7
Coating System of Example 1 of the Present Invention
[Base coat having a dry cured coating thickness of 1.5 mils (38.1 microns)
coated with Imron ® Elite clear coat having a dry cured coating thick-
ness of 2 mils (50.8 microns) both bake cured simultaneously
for 20 minutes at low bake temperature of 160° F. (71.1° C.)]

| Base Coat Ingredients | In grams |
|---|---|
| Polyurea binder prepared by Procedure 2 | 0 |
| Low bake temperature control agent | 300 |
| prepared by Procedure 3 | |
| Silica dispersion⁽¹⁾ | 0 |
| Acid functional acrylic copolymer ⁽²⁾ | 0 |
| Polyester ⁽³⁾ | 146 |
| Imron ® Yellow tint PT 144 | 3 |
| Imron ® Magenta tint PT 164 | 6 |
| Imron ® Black tint PT 105 | 19 |
| Imron ® Transparent yellow oxide tint PT 183 | 101 |
| Imron ® Medium fine aluminum tint PT 110 | 159 |
| Ethyl acetate from Eastman Chemical, | 65 |
| Kingsport, Tennessee | |
| Imron ® Activator 15305S (in | 250 |
| crosslinking component | |
| Total | 1049 |

Test Results

| | |
|---|---|
| Basecoat Sag dry film thickness | 5 mils (127 microns) |
| R (orange peel) at BC dry film | 7 |
| thickness of 1.5 mils (38.1 microns) | |
| measured by ASTM D3451 | |
| DOI at Base Coat dry film | 80 |
| thickness of 1.5 mils (38.1 microns) | |
| measured by ASTM D5767 | |
| Test Observations | good sag resistance |
| | and very smooth |
| | and good DOI |

Unless stated otherwise, all the ingredients were supplied by Axalta Coating Systems, LLC of Wilmington, Delaware.
Note:
⁽¹⁾⁻⁽³⁾ same as in Table 1.

TABLE 8
Ambient Temperature Curing
[Comparative Examples 7 and 8 coatings were cured for 24 hours
at ambient temperature in a range of from 60° F. (15° C.)
to 110° F. (43° C.) (Ingredient in grams)]

| | Comparative 7 | Comparative 8 |
|---|---|---|
| Silica dispersion⁽¹⁾ | 10.0 | 0.0 |
| BENTONE ® dispersion ⁽⁴⁾ | 0.0 | 0.0 |
| GARAMITE ® dispersion ⁽⁵⁾ | 0.0 | 0.0 |
| Low bake temperature | 0.0 | 37.0 |
| control agent prepared by | | |
| Procedure 3 | | |
| Acid functional acrylic | 8.8 | 4.0 |
| copolymer ⁽²⁾ | | |
| Polyester ⁽³⁾ | 18.0 | 15.0 |
| Violet tint PT 120 | 0.1 | 0.1 |
| Black tint PT 105 | 0.5 | 0.5 |
| Blue tint PT 122 | 3.9 | 3.9 |
| Red shade blue tint PT 124 | 11.2 | 11.2 |
| Aluminum tint PT 114 | 10.9 | 10.9 |
| Methyl amyl ketone | 14.0 | 10.0 |
| Ethyl acetate | 10.9 | 5.0 |
| Butyl acetate | 6.5 | 3.0 |
| Heptane | 1.7 | 1.7 |
| Ethyl 3-ethoxy propionate | 2.1 | 2.3 |
| Dibutyl tin dilurate | 0.01 | 0.01 |
| Imron ® Activator 15305S | 35.0 | 36.0 |
| Total [grams] | 133.6 | 140.6 |

Test Results

| | | |
|---|---|---|
| Minimum Dry Film | 4 | 3 |
| Thickness for Sag [mil] | | |
| R (orange peel) of dry film | 5 | 8 |
| thickness of 1.5 mils | | |
| measured by ASTM D3451 | | |
| DOI of dry film thickness | 70 | 75 |
| of 1.5 mils measured | | |
| by ASTM D5767 | | |
| Mottle measurement ⁽⁶⁾ | 6.7 | 4.5 |
| Coating appearance | Good sag | Medium sag |
| | resistance but | resistance, |
| | peely and poor | smooth and good |
| | mottle resistance | mottle resistance |

Unless stated otherwise, all the ingredients were supplied by Axalta Coating Systems, LLC of Wilmington, Delaware.
Note:
⁽¹⁾⁻⁽³⁾ same as in Table 1.
⁽⁴⁾ The BENTONE ® clay was from Elementis Specialties, London, United Kingdom, under respective registered trademark. BENTONE ® 34 dispersion was prepared according to U.S. Pat. No. 8,357,456, herein incorporated by reference.
⁽⁵⁾ GARAMITE ® clay was from Southern Clay Products, Gonzales, TX, USA, under respective registered trademark. GARAMITE ® dispersion was prepared according to U.S. Pat. No. 8,227,544, herein incorporated by reference.
⁽⁶⁾ Mottle measurement was performed using Cloud Runner available from BYK-Gardner GmbH, Geretsried, Germany.

TABLE 9
Ambient Temperature Curing
[Examples 2-4 coatings were cured for 24 hours
at ambient temperature in a range of from 60° F (15° C.)
to 110° F. (43° C.) (Ingredient in grams)

| | Example 2 | Example 3 | Example 4 |
|---|---|---|---|
| Silica dispersion⁽¹⁾ | 4.0 | 0.0 | 0.0 |
| BENTONE ® dispersion ⁽⁴⁾ | 0.0 | 10.0 | 0.0 |
| GARAMITE ® dispersion ⁽⁵⁾ | 0.0 | 0.0 | 10.0 |
| Low bake temperature | 18.0 | 18.0 | 18.0 |
| control agent prepared by | | | |
| Procedure 3 | | | |
| Acid functional acrylic | 3.9 | 2.0 | 2.0 |
| copolymer ⁽²⁾ | | | |
| Polyester ⁽³⁾ | 16.7 | 13.0 | 13.0 |
| Violet tint PT 120 | 0.1 | 0.1 | 0.1 |
| Black tint PT 105 | 0.5 | 0.5 | 0.5 |
| Blue tint PT 122 | 3.9 | 3.9 | 3.9 |
| Red shade blue tint PT 124 | 11.2 | 11.2 | 11.2 |
| Aluminum tint PT 114 | 10.9 | 10.9 | 10.9 |
| Methyl amyl ketone | 10.0 | 14.0 | 14.0 |
| Ethyl acetate | 15.0 | 10.9 | 10.9 |
| Butyl acetate | 4.1 | 6.5 | 6.5 |
| Heptane | 1.8 | 1.7 | 1.7 |
| Ethyl 3-ethoxy propionate | 1.2 | 2.1 | 2.1 |
| Dibutyl tin dilurate | 0.01 | 0.01 | 0.01 |
| Imron ® Activator 15305S | 35.5 | 35.0 | 35.0 |
| Total [grams] | 136.8 | 139.8 | 139.8 |

Test Results

| | | | |
|---|---|---|---|
| Minimum Dry Film | 4 | 4 | 4 |
| Thickness for Sag [mil] | | | |
| R (orange peel) of dry film | 7 | 7 | 7 |
| thickness of 1.5 mils | | | |
| measured by ASTM D3451 | | | |
| DOI of dry film thickness | 73 | 75 | 76 |
| of 1.5 mils measured | | | |
| by ASTM D5767 | | | |
| Mottle measurement ⁽⁶⁾ | 5.1 | 5.0 | 5 |
| Coating appearance | Good sag | Good sag | Good sag |
| | resistance, | resistance, | resistance, |
| | very smooth, | very smooth, | very smooth, |
| | good DOI and | good DOI and | good DOI and |
| | good mottle | good mottle | good mottle |
| | resistance | resistance | resistance |

Unless stated otherwise, all the ingredients were supplied by Axalta Coating Systems, LLC of Wilmington, Delaware.
Note:
⁽¹⁾⁻⁽⁶⁾ same as in Table 7.

From the foregoing, it would be clear to one of ordinary skill in the art that:

1. It is the unique combination of components within the low bake cure temperature control agent that gives rise to increasing sag resistance of the resultant coating;

2. The low bake cure temperature cure agent also simultaneously provides desired coating properties, such as smooth surface, and very good DOI (distinctness of image).

3. The low bake cure temperature cure agent produces a coating composition having low VOC at low bake temperatures in shorter cure times than the prior art.

Multi-layer coatings comprising a low bake cure temperature basecoat and a low bake cure temperature clear coat were also investigated. An example is provided below.

A low bake cure temperature clear coat was prepared by preparing a first acrylic resin by charging the constituents listed in Table 10 in a 12 liter reactor equipped with a stirrer, nitrogen inlet, condenser, dual above surface feeds, and a heating source.

TABLE 10
Constituents in First Acrylic Resin

| | Amount (grams) |
|---|---|
| Portion I. | |
| Methyl amyl ketone | 1249.44 |
| Portion II. | |
| Styrene (Sty) monomer | 1140.4 |
| Isobutyl methacrylate (IBMA) monomer | 1900.16 |
| 2-Hydroxyethyl methacrylate (HEMA) monomer | 1013.68 |
| 2-Hydroxypropyl methacrylate (HPMA) monomer | 1013.68 |
| Methyl amyl ketone | 130.56 |
| Portion III. | |
| Methyl amyl ketone | 60.24 |
| Portion IV. | |
| Methyl ethyl ketone | 529.2 |
| t-Butyl peroxyacetate | 593.12 |
| Portion V. | |
| Methyl ethyl ketone | 46.16 |
| Portion VI. | |
| Butyl acetate | 323.36 |
| Total | 8000 |

The First Acrylic Resin was prepared as follows. Portion I was charged into the reactor and heated to its reflux temperature. The monomers of Portion II were premixed and added at a uniform rate to the reactor over a 240 minute period while maintaining the constituents in the reactor at its reflux temperature. Concurrently, Portion IV, the initiator feed, was started and added with the monomers of Portion II at a uniform rate over the 240 minute period. After Portions II and IV were added, Portions III and V were used to rinse the feed tanks and added to the reactor. The resulting polymer solution was held at its reflux temperature for an additional 60 minutes. The polymer solution was then thinned with Portion VI and cooled to room temperature.

The resulting First Acrylic Resin had a theoretical solids content of 62.5%, and Sty/IBMA/HEMA/HPMA monomers in a weight ratio of 22.5/37.5/20.0/20.0. Gel permeation chromatography (GPC) was used to determine a weight average molecular weight of 3,766 and a number average molecular weight of 1,675. Formulated as above, the First Acrylic Resin comprised primary hydroxyl groups and secondary hydroxyl groups at a ratio of about 64:36, and had a theoretical glass transition temperature (Tg (theoretical)) of 68° C. calculated based on the weighted average of the literature values of the glass transition temperatures of the individual homopolymers.

The First Acrylic Resin was then used to prepare a low bake cure temperature clear coat formulation as provided in Table 11.

TABLE 11
Low Bake Cure Temperature Clearcoat Formulation

| Ingredients | Weight (gram) |
|---|---|
| First Acrylic Resin⁽¹⁾ | 776.6 |
| Second Acrylic Resin⁽²⁾ | 79.4 |
| Methyl Amyl Ketone | 96.2 |
| 2-ethylhexyl acetate | 52.0 |
| Mixed dimethyl esters of succinic, glutaric and | 23.4 |
| adipic acids | |
| Acrylic Polymer Solution ⁽³⁾ | 3.9 |
| Ultraviolet Absorber ⁽⁴⁾ | 11.6 |
| Light Stabilizer ⁽⁵⁾ | 11.6 |
| Urethane Catalyst Solution ⁽⁶⁾ | 14.2 |
| Cocoalkyldimethyl Amine ⁽⁷⁾ | 1.2 |
| Benzoic Acid | 10.0 |
| Silica Dispersion⁽⁸⁾ | 92.1 |
| Imron ® Activator 15305S ⁽⁹⁾ | 423.0 |
| Total | 1595.2 |

⁽¹⁾Preparation of the First Acrylic Resin is described above;
⁽²⁾The Second Acrylic Resin was a type of acrylic resin typically used in making conventional clear coats and was obtained from Axalta Coating Systems, Philadelphia, PA. The Second Acrylic Resin contained primary hydroxyl groups and secondary hydroxyl groups in a ratio of about 25:75 and had a theoretical glass transition temperature (Tg) of about 2.4° C.
⁽³⁾ The acrylic polymer solution: RESIFLOW S was available from Estron Chemical, Calvert City, KY
⁽⁴⁾ The ultraviolet absorber: TINUVIN 328 was available from BASF CORPORATION, Ludwigshafen, Germany
⁽⁵⁾ The light stabilizer: TINUVIN 292 was available from BASF CORPORATION, Ludwigshafen, Germany
⁽⁶⁾ The catalyst: FASCAT (R) 4202 CATALYST (dibutyl tin dilaurate) available from PMC ORGANOMETALLIX INC, Mount Laurel, NJ was used as 2% solution in ethyl acetate
⁽⁷⁾ The Cocoalkyldimethyl Amine: ARMEEN DMCD is available from AKZO NOBEL, Malvern, PA
⁽⁸⁾Silica Dispersion was obtained from Axalta Coating Systems, Philadelphia, PA
⁽⁹⁾ Silica Dispersion was obtained from Axalta Coating Systems, Philadelphia, PA

Thus, the exemplary low bake temperature clearcoat formulation provided in Table 11 comprises First and Second Acrylic Resins at a ratio of about 10:1. This results in a clear coat coating composition with primary hydroxyl groups and secondary hydroxyl groups present at a ratio of about 60:40.

An exemplary multi-layer coating system was prepared with the basecoat described above in Example 4 and the clear coat formulation provided in Table 11. The basecoat was applied to a metal substrate via a conventional spraying technique such as is typical in the automotive coating field. The clear coat formulation was applied by spray wet-on-wet over the basecoat layer to form a clear coat layer. The basecoat/clear coat system was cured at 160° F. for about 20 minutes, which resulted in a dry, hard film.

Accordingly, various embodiments for low VOC (volatile organic component) low bake temperature curable coating compositions suitable for use in automotive OEM (original equipment manufacturer) and refinish applications and processes for producing coatings at low bake temperatures are described herein. In particular, multi-layer coatings comprising a low bake temperature curable basecoat and a clear coat coating composition comprising primary and secondary hydroxyl groups in a ratio of 30:70 to about 80:20, such as about 35:65 to about 75:25, such as about 40:60 to about 70:30, such as about 45:55 to about 70:30, such as about 50:50 to about 70:30, such as about 55:65 to about 70:30, such as about 60:40 to about 70:30, such as about 65:35 to about 70:30, are provided. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A multi-layer coating system comprising:
a low bake temperature curable base coat coating composition comprising:
a crosslinkable component comprising an acid functional acrylic copolymer polymerized from a monomer mixture comprising 2 percent to 12 percent of one or more carboxylic acid group containing monomers, percentages based on total weight of the acid functional acrylic copolymer,
a crosslinking component; and
a low bake temperature control agent comprising a rheology component chosen from an amorphous silica, a clay, or a combination thereof, the rheology component present in an amount of from about 0.1 to about 10 weight percent, and about 0.1 weight percent to about 10 weight percent of polyurea, said percentages based on total weight of the crosslinkable and crosslinking components; and
a clear coat coating composition comprising an acrylic copolymer component comprising one or more acrylic polymers, wherein the clear coat coating composition comprises primary hydroxyl and secondary hydroxyl groups at a ratio of about 30:70 to about 80:20, and wherein the clear coat coating composition overlies and is in contact with the low bake temperature curable base coat coating composition.

2. The multi-layer coating composition of claim 1, wherein said acrylic copolymer of said clear coat coating composition comprises an acrylic polymer polymerized from a monomer mixture comprising a hydroxy alkyl acrylate, a hydroxy alkyl methacrylate, or a mixture thereof, wherein an alkyl group in said hydroxy alkyl acrylate and/or hydroxy alkyl methacrylate is 1 to 4 carbon atoms.

3. The multi-layer coating composition of claim 1, wherein said acrylic copolymer of said clear coat coating composition comprises an acrylic polymer polymerized from a monomer mixture comprising hydroxy ethyl acrylate, hydroxy propyl acrylate, hydroxy isopropyl acrylate, hydroxy butyl acrylate, hydroxy ethyl methacrylate, hydroxy propyl methacrylate, hydroxy isopropyl methacrylate, hydroxy butyl methacrylate, or a mixture thereof.

4. The multi-layer coating composition of claim 1, wherein said acrylic copolymer of said clear coat coating composition comprises an acrylic polymer polymerized from a monomer mixture comprising styrene, isobutyl methacrylate (IBMA), 2-hydroxyethyl methacrylate (HEMA), 2-hydroxypropyl methacrylate (HPMA), or a mixture thereof.

5. The multi-layer coating composition of claim 1, wherein said acrylic copolymer of said clear coat coating composition comprises a single acrylic resin.

6. The multi-layer coating composition of claim 1, wherein said acrylic copolymer of said clear coat coating composition comprises a plurality of acrylic resins.

7. The multi-layer coating composition of claim 1, wherein said acrylic copolymer of said clear coat coating composition comprises an acrylic resin with a theoretical glass transition temperature (Tg (theoretical)) of about 25° C. to about 95° C.

8. The multi-layer coating composition of claim 1, wherein said acrylic copolymer of said clear coat coating composition comprises an acrylic resin with a ratio of primary hydroxyl groups to secondary hydroxyl groups of about 35:65 to about 75:25.

9. A clear coat coating composition comprising an acrylic copolymer component comprising one or more acrylic polymers, wherein the clear coat coating composition comprises primary hydroxyl and secondary hydroxyl groups at a ratio of about 30:70 to about 80:20.

10. The clear coat coating composition of claim 9, wherein said acrylic copolymer comprises an acrylic polymer polymerized from a monomer mixture comprising a hydroxy alkyl acrylate, a hydroxy alkyl methacrylate, or a mixture thereof, wherein an alkyl group in said hydroxy alkyl acrylate and/or hydroxy alkyl methacrylate is 1 to 4 carbon atoms.

11. The clear coat coating composition of claim 9, wherein said acrylic copolymer comprises an acrylic polymer polymerized from a monomer mixture comprising hydroxy ethyl acrylate, hydroxy propyl acrylate, hydroxy isopropyl acrylate, hydroxy butyl acrylate, hydroxy ethyl methacrylate, hydroxy propyl methacrylate, hydroxy isopropyl methacrylate, hydroxy butyl methacrylate, or a mixture thereof.

12. The clear coat coating composition of claim 9, wherein said acrylic copolymer comprises an acrylic polymer polymerized from a monomer mixture comprising styrene, isobutyl methacrylate (IBMA), 2-hydroxyethyl methacrylate (HEMA), 2-hydroxypropyl methacrylate (HPMA), or a mixture thereof.

13. The clear coat coating composition of claim 9, wherein said acrylic copolymer comprises a single acrylic resin.

14. The clear coat coating composition of claim 9, wherein said acrylic copolymer comprises a plurality of acrylic resins.

15. The clear coat coating composition of claim 9, wherein said acrylic copolymer comprises an acrylic resin with a theoretical glass transition temperature (Tg (theoretical)) of about 25° C. to about 95° C.

16. The clear coat coating composition of claim 9, wherein said acrylic copolymer comprises an acrylic resin with a ratio of primary hydroxyl groups to secondary hydroxyl groups of about 45:55 to about 80:20.

17. A process for producing a multi-layer coating on a substrate comprising:
(a) mixing a cross-linkable component, a crosslinking component and a bake temperature control agent to form a base coat pot-mix, said crosslinkable component comprising an acid functional acrylic copolymer polymerized from a monomer mixture comprising about 2 weight percent to about 12 weight percent of carboxylic acid group containing monomer based on total weight of the acid functional acrylic copolymer, and wherein said bake temperature control agent comprises a rheology component chosen from an amorphous silica, a clay, or a combination thereof, the rheology component present in an amount of about 0.1 weight percent to about 10 weight percent, and about 0.1 weight percent to about 10 weight percent of polyurea, said percentages based on total weight of the crosslinkable and crosslinking components;
(b) applying a layer of said base coat pot-mix over said substrate;
(c) applying a layer of a clear coat coating composition disposed over and in contact with a layer of basecoat pot-mix to form a multi-layer coating composition, wherein said clear coat coating composition comprises an acrylic copolymer component comprising one or more acrylic polymers, wherein the clear coat coating composition comprises primary hydroxyl and secondary hydroxyl groups at a ratio of about 30:70 to about 80:20; and
(d) curing the multi-layer coating composition on said substrate.

18. The process of claim 17, wherein applying a layer of said base coat pot-mix comprises applying a plurality of layers of said base coat pot-mix, applying a layer of a clear coat composition comprises applying a plurality of layers of clear coat composition, or both.

19. The process of claim 17, wherein said curing is conducted at a bake temperature of about 60° F. (15° C.) to about 200° F. (93° C.).

20. The process of claim 17, wherein said substrate is an automotive body, industrial equipment or construction equipment.
